(19) United States
(12) Patent Application Publication
(10) Pub. No.: US 2007/0215788 A1
(43) Pub. Date: Sep. 20, 2007

(54) Exposure apparatus

(76) Inventors: Takeshi Nishihara, Wakayama-shi (JP); Akihiko Toki, Wakayama-shi (JP); Hisashi Oda, Wakayama-shi (JP)

Correspondence Address: SMITH PATENT OFFICE, 1901 PENNSYLVANIA AVENUE N W, SUITE 901, WASHINGTON, DC, 20006, US

(21) Appl. No.: 11/723,097

(22) Filed: Mar. 16, 2007

(30) Foreign Application Priority Data
Mar. 17, 2006 (JP) 2006-075227

(51) Int. Cl. G01J 1/32

(52) U.S. Cl. 250/205

(57) ABSTRACT

An exposure apparatus of the invention has a dot array head of a fluorescent type having light-emitting units UR, UG, UB of three primary colors. A controller E is provided with an area dividing unit that divides the dot array head into an image area, in which control of light emission based on image data is performed, and the other non-image areas. In addition, a dot array head control unit in the controller E comprises a light emission control unit that controls the dot array head such that light is emitted based on the image data in the image area and dummy light emission takes place in the non-image area when exposing photographic paper. The dummy light emission data is created by the dummy light emission data creating unit, based on image data corresponding to a single dot D1 adjacent to a boundary of the image area and the non-image area.

### BACKGROUND OF THE INVENTION

1. Field of the Invention

The invention relates to an exposure apparatus having a dot array head for exposing a photosensitive medium based on image data.

2. Description of Related Art

As it has comes a digital age, it has been developed a means for supporting the digital in an exposure apparatus that exposes an image on photosensitive paper. At early stage of the development, a hybrid device supporting analog and digital took measures to attach an index digital print to a print of analog exposure. In such hybrid device, the exposure apparatus is generally provided with a vacuum fluorescent print head (hereinafter, referred to as ‘VF’ head). Herein, the VF head consists of fluorescent light-emitting devices, wherein a cathode electrode emitting thermal electrons and many anode electrodes having fluorescent bodies coated with predetermined pitch and size are enclosed in a vacuum vessel.

In the VF head, during a manufacturing process, gas components existing in the atmospheres, as remaining gas, are put into the fluorescent light-emitting device or the vacuum vessel in which the various electrodes are enclosed. Accordingly, the fluorescent light-emitting device is deactivated due to the attachment of the remaining gas, so that the light emission thereof is obstructed. The attached remaining gas is separated from a surface of the fluorescent light-emitting device in correspondence to an amount of the light emission of the fluorescent light-emitting device, and the attachment amount is again increased as the time elapses after the light emission. Therefore, even when the same density data is provided, exposure amounts of the fluorescent light-emitting devices are different due to the difference between the attachment amounts of the remaining gas, thereby causing the exposures to be non-uniform. In order to solve the problem, it is suggested a technology wherein all the fluorescent light-emitting devices are subject to the light emission for a predetermined time period before the exposure (it is so-called pre-light emission) and load is applied to the head, thereby causing the light emissions of the fluorescent light-emitting devices to be uniform.

In addition, the fluorescent light-emitting device constituting the VF head has a temperature quenching characteristic (the amount of light emission is decreased as the temperature is increased), and the amounts of light emission are different even in the same head depending on the exposure time. In other words, when the light emission is made only for a print width part with respect to an effective light-emitting width of the head, thereby conducting the exposure, the fluorescent light-emitting devices at the print width part and parts except the print width have different amounts of light emission in the next light emission. Accordingly, when the print width is increased, there occurs a hysteresis phenomenon, i.e., a difference of the exposure amounts due to the difference of the amounts of light emission and further a difference of densities of an image at the part corresponding to the previous width and the part corresponding to the newly added width. Meanwhile, in the case of the conventional index print, since the print width is not constant, the exposure non-uniformity due to the temperature quenching characteristic is taken little notice of.

In recent years, however, as the print size is diversified and the print width is varied, the exposure non-uniformity due to the temperature quenching characteristic of the VF head becomes an issue. In particular, in the case of improving a processing capacity of the apparatus to carry out the print in succession and in large quantities, it is difficult to suppress the exposure non-uniformity. Therefore, the applicant suggested a technology wherein dummy light-emitting data relating to dummy light emission in a non-image area is generated based on image data used for light emission in an image area, and the light is emitted based on the image data in the image area and the dummy light emission takes place in the non-image area when a photosensitive medium is exposed (for example, Japanese Unexamined Patent Publication No. 2003-341124).

### SUMMARY OF THE INVENTION

The applicant researched over and over again and thus found out that when the hysteresis phenomenon adjacent to a boundary of the image area and the non-image area is suppressed, the exposure non-uniformity due to the temperature quenching characteristic can be suppressed more effectively

According to a first aspect of the invention, there is provided an exposure apparatus comprising a dot array head, an area dividing unit and a light emission control unit. The dot array head exposes a photosensitive medium based on an image data item. The area dividing unit divides the dot array head into an image area in which control of light emission based on an image data item relating to exposure is performed and a non-image area. The light emission control unit controls the dot array head so that light is emitted based on the image data item in the image area and dummy light emission takes place in the non-image area when the photosensitive medium is exposed. The exposure apparatus further comprises a dummy light emission data item creating unit that creates a dummy light emission data item relating to the dummy light emission in the non-image area, based on image data items, among the image data items used for light emission in the image area, corresponding to a number of dots adjacent to a boundary of the image area and the non-image area.

Herein, the dot array head consists of a number of devices disposed in a main scanning direction and includes a vacuum fluorescent print head, a PLZT head or the like, for example.

According to the above structure, when the photosensitive medium is exposed, the light not only is emitted in the image area of the dot array head, the dummy light emission also takes place in the non-image area based on the image data items corresponding to the dots of an end of the image area, so that it is possible to effectively suppress the exposure non-uniformity due to the temperature quenching characteristic. In other words, when the image data relating to the dummy light emission is created based on a number of dots over the entire image area (for example, when the image data relating to the dummy light emission is created based on an average value of the image data corresponding to a number of dots over the entire image area), there is a case where the image data corresponding to the outermost dot of the image area is highly different from the image data corresponding to a dot of the non-image area (a dot adjacent to the image area, in the non-image area). To the contrary, according to the invention, since the image data relating to the dummy light emission is created based on the image data corresponding to a number of dots at the end of the image area, the image data corresponding to the outermost dot of the image area is relatively close to the image data corresponding to a dot of the non-image area (a dot adjacent to the image area, in the non-image area). As a result, since a difference of steps at the boundary of the image area and the non-image area is not conspicuous, there is no inconvenience in appearance.

Accordingly, since it is possible to drastically suppress a difference of densities at the end of the image area, which particularly becomes an issue when a print width is changed into a large width, it is possible to cope with various sizes of prints. In addition, by carrying out the dummy light emission, it is possible to reduce the time of pre-light emission, which has been conventionally carried out as measures for the exposure non-uniformity resulting from a difference of attachment amounts of the remaining gas in the dot array head, or the processing time necessary for a light quantity uniforming process carried out in advance so that the amounts of light emission are uniform for each light-emitting device. Accordingly, it is possible to suppress the exposure non-uniformity while sustaining the high processing capacity. Further, the time of the pre-light emission, which is typically carried out for the overall dot array head, is reduced, so that the load for the dot array head is decreased and the lifespan of the light emission is much prolonged, as compared to the prior art.

### BRIEF DESCRIPTION OF THE DRAWINGS

Other and further objects, features and advantages of the invention will appear more fully from the following description taken in connection with the accompanying drawings in which:

FIG. 1 schematically shows a structure of a photograph print system by an exposure apparatus according to an embodiment of the invention;

FIG. 2 is a perspective view showing a reciprocal movement mechanism of a dot array head;

FIG. 3 is a cross sectional view of a dot array head;

FIG. 4 is a cross sectional view of a light emitting module in the dot array head shown in FIG. 3;

FIG. 5 is a schematic view showing a disposition of light emitting dots in the light emitting module shown in FIG. 4;

FIG. 6 is a block diagram showing a structure of a controller; and

FIG. 7 shows a part adjacent to a boundary of an image area and a non-image area.

### DESCRIPTION OF THE PREFERRED EMBODIMENTS

Hereinafter, a preferred embodiment of the present invention will be described with reference to the accompanying drawings. In the mean time, although the following embodiment will be described with reference to an exposure apparatus using a VF head of a fluorescent type as a dot array head, the invention can be applied to the other line heads such as PLZT line head and a surface exposure type head such as CRT, liquid crystal and the like.

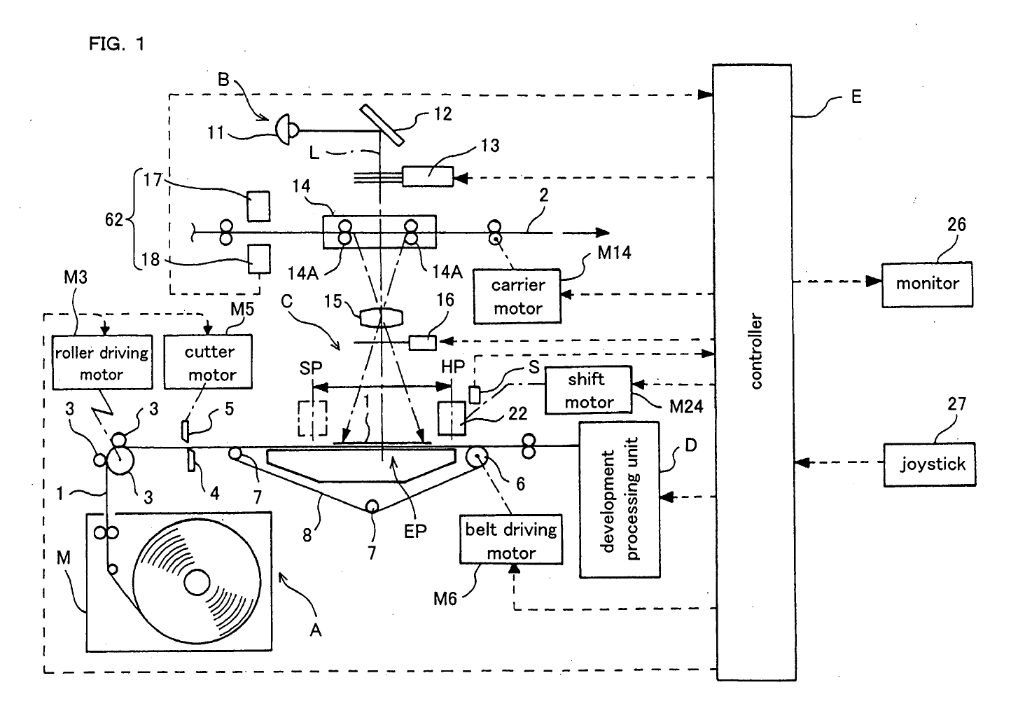

First, a photograph print system by an exposure apparatus according to an embodiment of the invention is described with reference to FIG. 1. The exposure apparatus comprises a delivery unit A that cuts photographic paper 1, which is a photosensitive medium received in a paper magazine M, into a print size and delivers it to an exposure position EP, a projection exposure unit B that exposes the photographic paper 1, which is set in the exposure position EP, using light having transmitted a photograph film 2 and a digital exposure unit C that exposes the photographic paper 1, which is set in the exposure position EP, based on image data which is digital-signalized. In the photograph print system by the exposure apparatus, the exposed photographic paper 1 is delivered to a development processing unit D, subject to processes of development, bleach-fix, stabilization, drying and the like and then discharged.

The delivery unit A has a roller mechanism consisting of several delivery rollers 3 for delivering the photographic paper 1, which is received in the paper magazine M, while pressing it, and a roller driving motor M3 for driving the delivery rollers 3. In addition, the delivery unit A has a cutter mechanism consisting of a fixed knife 4 and a movable knife 5 cutting the photographic paper 1 into a print size and a cutter motor M5 for driving the moveable knife 5. Further, the deliver unit A has a belt delivery mechanism consisting of a delivery belt 8 wound on a drive pulley 6 and two idle pulleys 8 and a belt driving motor M6 for rotating the drive pulley 6. With such structure, the delivery unit A delivers the photographic paper 1 from the paper magazine M with the roller delivery mechanism, cuts the photographic paper 1 into a print size through the cutter mechanism to deliver it to the delivery mechanism and stops the photographic paper 1 at the exposure position EP on a delivery route of the belt delivery mechanism.

The projection exposure unit B transmits light, which is emitted from a light source 11 such as halogen lamp and the like, to the photograph film 2, which is supported to a film carrier 4, through a mirror 12 and dimmer filter 13 along a light axis L shown in a dashed dotted line, and projects the light on the photographic paper 1, which is set in the exposure position EP, through a shutter 16. The film carrier 14 has several press rollers 14A that delivers the photograph film 2 while pressing it, and a carrier motor M14 for driving the press rollers 14A.

In addition, in order to image data of the photograph film 2, which is used for exposure in the digital exposure unit C that will be specifically described, a scanner 63 consisting of a light source 17 and a line sensor 18 of a CCD type is provided to the delivery system of the photograph film 2. The scanner 62 drives the carrier motor M14 at a set speed to deliver the photograph film 2 at the set speed into a longitudinal direction (sub-scanning direction) and reads the image data with the line sensor 18 along a direction (main scanning direction) perpendicular to the delivery direction of the photograph film 2 at a timing synchronized with the delivery speed of the photograph film 2. In the mean time, as the image data used for exposure in the digital exposure unit C, data photographed with a digital camera or stored in a CD-ROM may be used, in addition to the data read by the scanner 62.

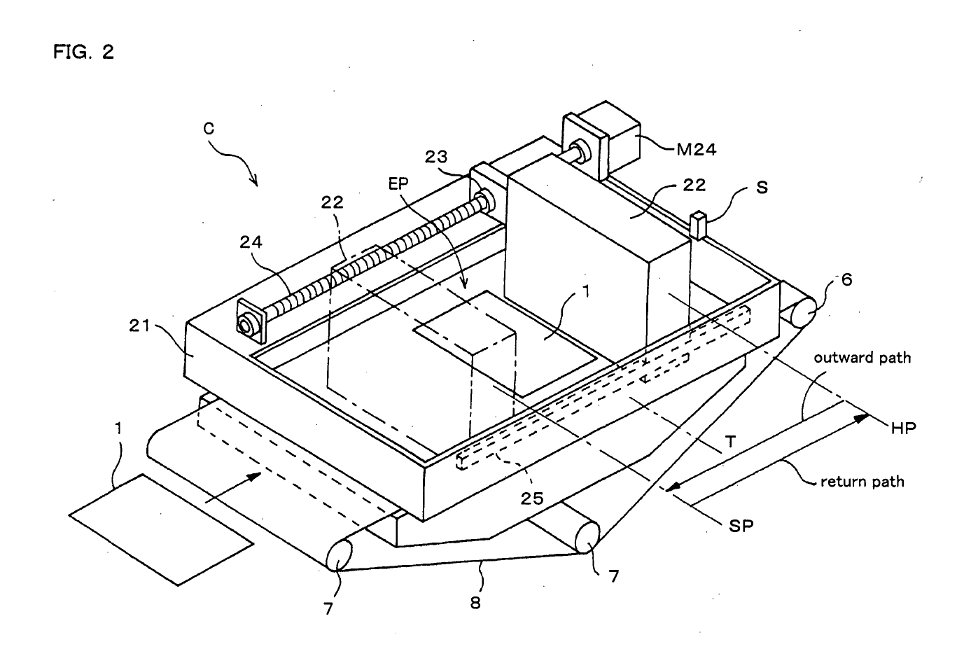

The digital exposure unit C has a dot array head 22, which is supported to be moveable in the delivery direction of the photographic paper 1, and a reciprocal movement mechanism for reciprocally moving the dot array head 22 from a stop position (hereinafter, referred to as SP) to a home position (hereinafter, referred to as HP). As shown in FIG. 2, the reciprocal movement mechanism is attached to a frame 21, which is a quadrangle shape when viewed from a plane disposed at an upper plane of the delivery belt 8 in the belt delivery mechanism, and comprises a ball screw 24 extending along one side of the frame 21, a nut 23 screw-engaged to the ball screw 24 and supporting an end of the dot array head 22, a guider 25 mounted to a side opposite to the side to which the ball screw 25 of the frame 21 is provided and a shift motor M24 for driving the ball screw 24 into both forward and reverse directions. In addition, the digital exposure unit C is provided with a home position sensor S for detecting the dot array head 22 located at the HP, as shown in FIG. 2. Herein, a route in which the dot array head 22 is moved from the HP to the SP is referred to as an outward path and a route in which the dot array head is moved from the SP to the HP is referred to as a return path. In addition, the exposure position EP, in which the photographic paper 1 is set to carry out the exposure in the dot array head 22, is such a position that an end at a delivery downstream of the photographic paper 1 is coincident to the SP and the photographic paper 1 is disposed between a position T and the SP.

The photograph processing system according to this embodiment has, as shown in FIG. 1, a controller E which will be specifically described later. In the delivery unit A, the roller driving motor M3, the cutter motor M5 and the belt driving motor M6 are driven based on a signal from the controller E. In the projection exposure unit B, the dimmer filter 13, the carrier motor M14 and the shutter 16 are operated based on a signal outputted from the controller E and the image data, which is read by the scanner 62 such as line sensor 18 provided to the delivery system of the photograph film 2, is transmitted to the controller E. Additionally, in the digital exposure unit C, the shift motor M24 is driven based on a signal outputted from the controller E and the image data, which is transmitted to the controller E from the scanner 62, is transmitted to the dot array head 22. Further, the controller E is adapted to control the development processing unit D also. In addition, the controller E is connected with a monitor 26 for displaying a variety of information including the image data of the controller E and a joystick 27 for inputting various information to the controller E.

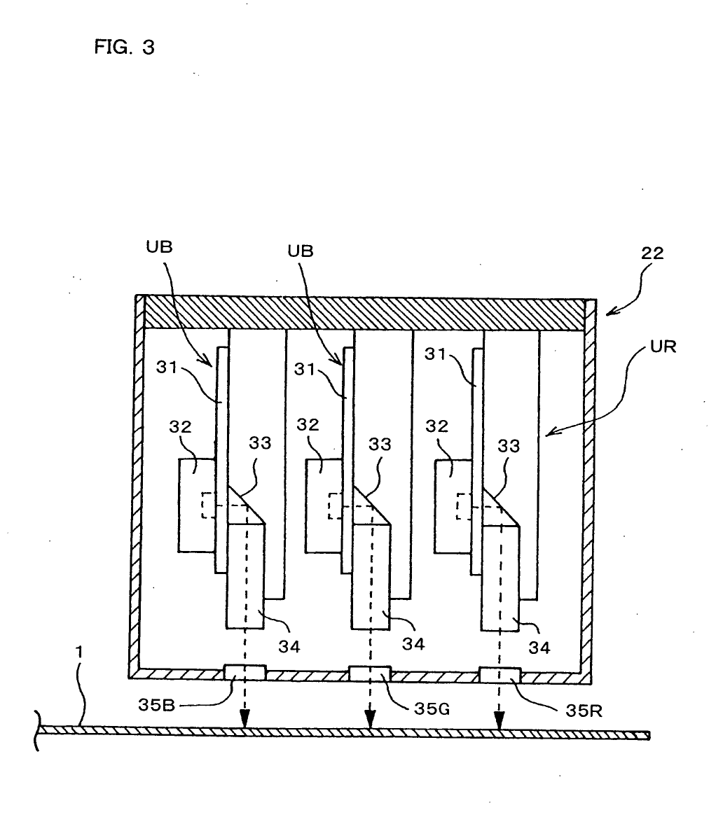

In the followings, the dot array head 22 of this embodiment is described with reference to FIGS. 3 to 6. In this embodiment, the dot array head 22 is a VF line head and has a light-emitting system of three rows of three primary colors, i.e., red (R), green (G) and blue (B) along the direction (main scanning direction) perpendicular to the delivery direction of the photographic paper 1.

FIG. 3 is a cross sectional view of the dot array head 22. As shown in FIG. 3, the dot array head 22 has individual light-emitting units UR, UG, UB each of which comprises a plate 31, a light-emitting module 32 mounted to the plate 31, a prism 33 guiding the light, which is emitted into a horizontal direction from the light-emitting module 32, into a downward direction, a SELFOC lens array 34 forwarding the light emitted from the prism 33 to a photosensitive surface of the photographic paper 1 and red (R), green (G) and blue (B) filters 35R, 35G, 35B, respectively. The lights of red (R), green (G) and blue (B) are respectively emitted from each of the light-emitting units UR, UG, UB to a case constituting an outer wall of the dot array head 22. In the mean time, each of the light-emitting units UR, UG, UB is structured in a same manner, except the filters 35R, 35G, 35B.

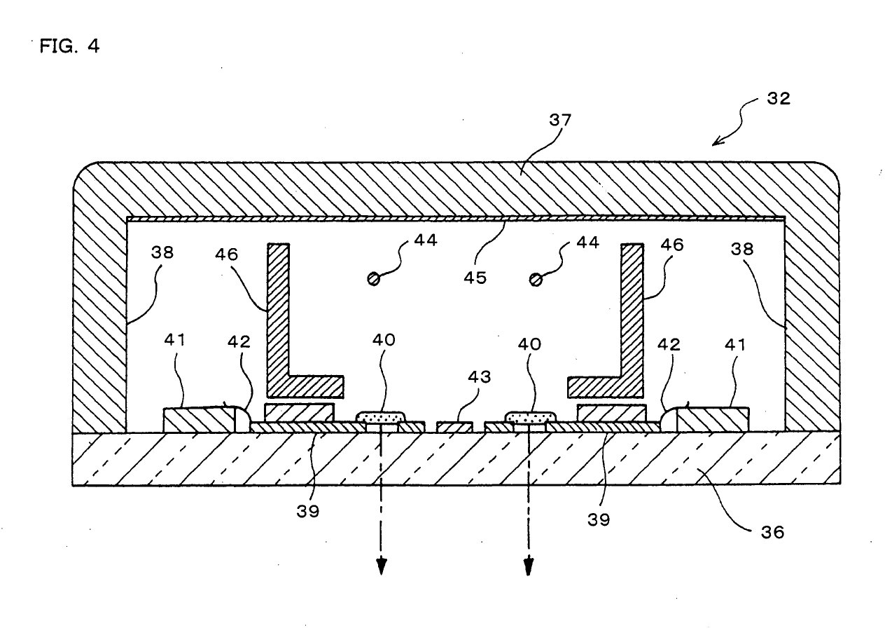

FIG. 4 is a sectional view taken along a width direction of the light-emitting module 32 in each of the light-emitting units UR, UG, UB. The light-emitting module 32 is made of transparent glass and has a housing formed by a positive electrode substrate 36 and a rear substrate 37, which are disposed opposite to each other, and side walls 38, in which housing is maintained under high vacuum. On an inner surface of the positive electrode substrate 36 of the housing, conductive films 39 made of aluminum having an opening and the like, connected to an electrode of a driving IC 41 through a wiring 42, functioning as an anode electrode and having a frame shape are disposed in two rows along a longitudinal direction of the positive electrode substrate 36. A fluorescent body 40 is adhered to each opening of the conductive films 39 of a frame shape so that it sufficiently covers the opening. The conductive films 39 of a frame shape and the fluorescent body 40 are collectively referred to as a fluorescent light-emitting device.

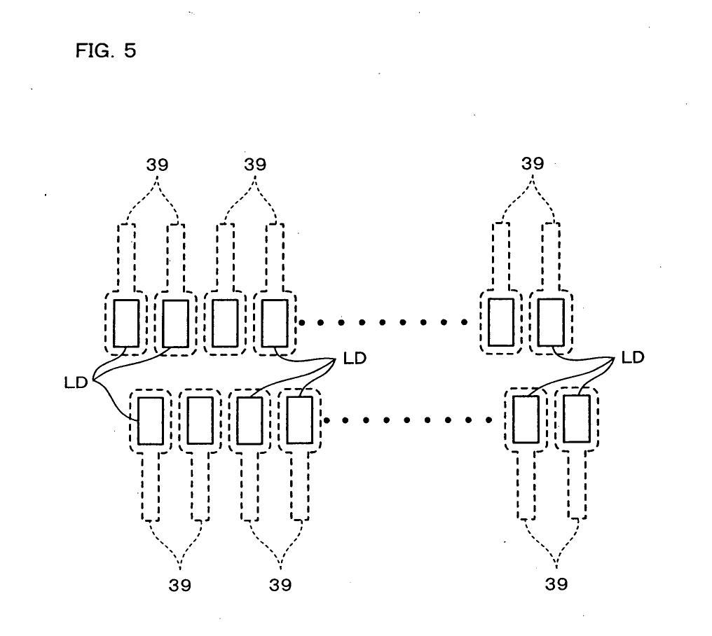

In addition, as shown in FIG. 5, the openings (corresponding to light-emitting dots (LD)) of the conductive films 39 of a frame shape are formed at a predetermined distance and the openings of each row are disposed in a zigzag form in which the openings are deviated from each other.

In addition, as shown in FIG. 4, a planar control electrode 43 made of aluminum and the like, applied with a positive voltage all the time and having a function of making adjacent electric fields constant is provided between the conductive films 39 of a frame shape which are disposed in two rows. Negative electrodes 44 having a filament shape and functioning as a cathode are respectively mounted at positions spaced toward the rear substrate 37 from each fluorescent body 40. Thermal electrons discharged from the negative electrodes 44 through current application are guided to the conductive film 39 of a frame shape, so that the fluorescent body 40 emits the light. In addition, in order to prevent active current from flowing in the wiring 42 of the conductive films 39 of a frame shape or a wiring of the planar control electrode 43 to obstruct the uniform light emission, a pair of shield electrodes 46 is disposed at positions more outer than the negative electrodes 44. In addition, on an inner surface of the rear substrate 37 of the housing, it is formed a tin oxide film 45 having functions of preventing electrification through conduction and keeping the light emitted from the fluorescent body 40 from being reflected at the positive electrode substrate by a reflection preventing layer formed on a surface thereof and made of a transmissive conductive film.

When it is desired to perform exposure of the image data to the photographic paper 1 by the dot array head 22 structured as described above, while applying current to the negative electrode 44 to generate thermal electrons, the conductive film 39 of a frame shape, which corresponds to the light-emitting dot (LD) to be light-emitted through the driving IC 41, is designated and a voltage to be applied to it is controlled, so that the thermal electrons are impacted on the fluorescent body 40 by an electric field generated at the corresponding conductive film 39 of a frame shape. Due to the impact of the thermal electrons on the fluorescent body 40, the fluorescent body 40 reaches its excited state and emits light. When the fluorescent body 40 emits the light, the light emitted from the opening of the conductive film 39 of a frame shape transmits the positive electrode substrate 36 of the light-emitting module 32 and is then guided to the photographic paper 1 via the prism 33, the SELFOC lens array 34 and the filter, as shown in FIG. 3, so that a latent image of the image data is formed in a dot unit on a photosensitive surface of the photographic paper 1.

In the mean time, as a method of adjusting an amount of exposure to the photographic paper 1, there are a method of adjusting an amount of the light emission of the fluorescent body 40 through a setting of voltage to be applied to the conductive film 39 of a frame shape, a method of adjusting a light-emitting time period of the fluorescent body 40, a method of combining the methods and the like.

According to this embodiment, in the dot array head 22, a density of each color constituting the image data is 12 bits (i.e., 36 bits color of R, G and B) and standard pulses are supplied as the number corresponding to the density, so that a desired density is obtained. For example, when a density of the overall color is “0,” the photographic paper 1 is exposed for the longest time, so that a latent image of a black color is formed. In addition, when a density of the overall color is “1023,” the photographic paper 1 is not exposed and a latent image of a white color is formed.

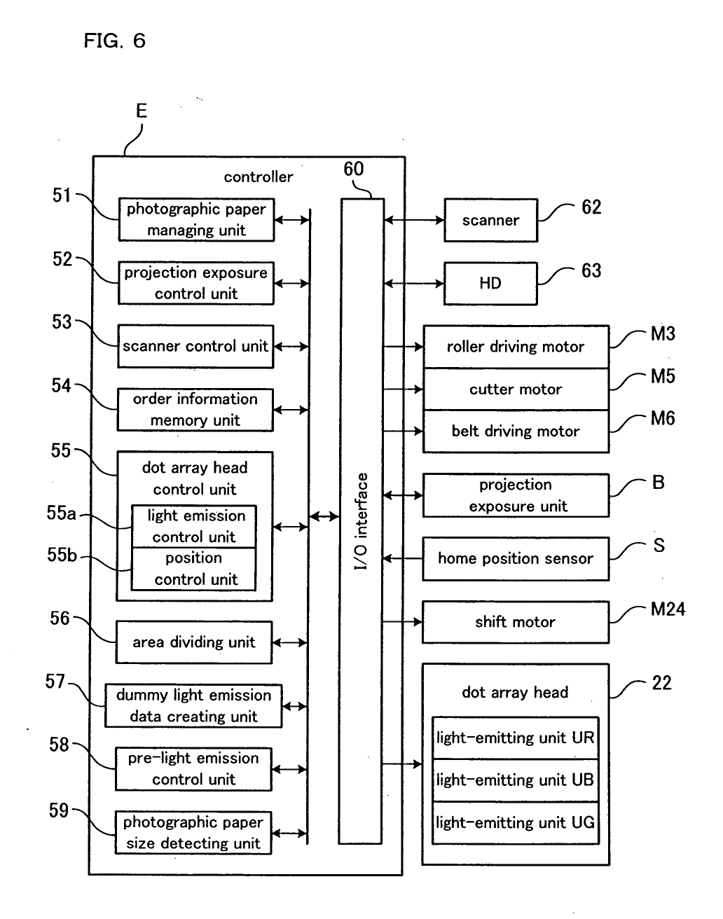

In the followings, the structure of the controller E in the photograph processing system in FIG. 1 is more specifically described with reference to FIG. 6. The controller E comprises a CPU, a ROM, a RAM and the like which are combined with a variety of software stored in a hard disk 63, which will be described later, thereby constituting each unit in the controller E, which will be described later.

As shown in FIG. 6, the controller E has a photographic paper managing unit 51, a projection exposure control unit 52, a scanner control unit 53, an order information memory unit 54, a dot array head control unit 55, an area dividing unit 56, a dummy light emission data creating unit 57, a pre-light emission control unit 58 and a photographic paper size detecting unit 59. The respective units and an I/O interface 60 are connected so that they can transmit and receive the data through a bus line. The I/O interface 60 is connected to the scanner 62 that consists of the light source 17 and the line sensor 18 and reads the image data of the photograph film 2 (refer to FIG. 1), a hard disk (hereinafter, referred to as HD) 63 that stores the image data read by the scanner 62 and the projection exposure unit B so that it can transmit and receive the data to and from each of them. In the mean time, the roller driving motor M3, the cutter motor M5 and the belt driving motor M6 of the delivery unit A, the shift motor M24 for driving the dot array head 22 to reciprocally move, and the light-emitting units UR, UG, UB for each color of the dot array head 22 are connected to the I/O interface so that they can be respectively supplied with the signals from the I/O interface 60. In addition, the I/O interface 60 is connected to the home position sensor S for detecting the dot array head 22 located at the HP so that the I/O interface can receive a signal outputted from the home position sensor S.

The photographic paper managing unit 51 controls the roller driving motor M3, the cutter motor M5 and the belt driving motor M6 to set the photographic paper 1 at the exposure position EP, which is cut into a print size based on order information. The projection exposure control unit 52 controls the dimmer filter 13, the shutter 16 and the carrier motor M14 of the projection exposure unit B (refer to FIG. 1) to enable the image data of the photograph film 2 to be projection-exposed. The scanner control unit 53 controls such that the image recorded on the photograph film 2 is digital-signalized and acquired as the image data with the scanner 62, and stores the acquired image data in the HD while managing it in an order unit. The order information memory unit 54 stores order information including a variety of information such as image data to be transmitted to the dot array head 22, a print size, the number of prints and the like.

The dot array head control unit 55 comprises a light emission control unit 55a, which is a light emission control means according to the invention, and a position control unit 55b. When exposing the photographic paper 1, the light emission control unit 55a controls the dot array head 22 so that light is emitted based on the image data in the image area and dummy light emission takes place in the non-image area, with respect to the image area and the non-image area divided by the area dividing unit 56 which will be described later. When controlling the dot array head 22, the light emission control unit transmits the respective information of red (R), green (G) and blue (B) of the image data to the light-emitting units UR, UG, UB of the dot array head 22, in synchronization with a moving speed of the dot array head 22. More specifically, in each light-emitting unit, the light emission control unit controls the conductive films 39 of a frame shape or the negative electrodes 44 in the light-emitting module 37 shown in FIG. 4, and a driving pulse is thus transmitted to a head driver (not shown) and the like so that each of the fluorescent light-emitting devices emits the light for a proper time period.

In addition, the position control unit 55b receives a signal outputted from the home position sensor S and counts the received signal and a driving signal supplied to the shift motor M24, thereby controlling the dot array head 22 to reciprocally move between the HP and the SP.

The area dividing unit 56 is a means for dividing areas of the invention and divides the dot array head 22 into an image area, in which a control of light emission based on the image data relating to the exposure is performed, and a non-image area. In the mean time, the image area may be determined based on a size of the photographic paper 1, which is an exposure object, detected by the photographic paper size detecting unit 59 mounted to the controller E. Alternatively, it may be determined based on designation by an operator. Meanwhile, even when the photographic papers of a same size are used, an image area becomes different depending on the delivery routes. Accordingly, the area dividing unit 56 divides an image area and a non-image area, considering the delivery route information of the photographic paper, too. The non-image area is an area except the image area of the dot array head 22. The two areas of the dot array head 22, which are divided by the area dividing unit 56, emit the light, respectively, based on the control of the light emission control unit 55a.

The dummy light emission data creating unit 57 creates dummy light emission data relating to the dummy light emission in the non-image area, based on image data, among the image data used for light emission in the image area, corresponding to a single dot adjacent to a boundary of the image area and the non-image area. A sequence of creating the dummy light emission data will be described later. The dummy light emission data created by the dummy light emission data creating unit 57 is supplied to the light emission control unit 55a of the dot array head control unit 55 and the dot array head 22 performs the dummy light emission in the non-image area.

In addition, the controller E is provided with the pre-light emission control unit 58. Thereby, while the photographic paper 1 does not exist at the exposure position EP between prints of the photographic paper 1, all the fluorescent light-emitting devices of the dot array head 22 are made to emit light (pre-light emission) at a half duty for a predetermined time period, so that a temperature difference between the image area and the non-image area can be reduced. As a result, the exposure non-uniformity due to the temperature quenching characteristic can be further suppressed and the exposure non-uniformity due to a difference of attachment amounts of the remaining gas on a surface of the fluorescent body 40 can be suppressed. In the mean time, the pre-light emission may be performed every time, between the print and the print, every predetermined time by monitoring operation time of the dot array head 22, after exposing a predetermined number of the photographic papers 1, or before starting a day's work. Further, in the pre-light emission, in addition to exposing all the florescent light-emitting devices of the dot array head 22 at a full duty, data having reversed the light emission data in the previous exposure may be used, or data calculated from a density having reversed an accumulated density value of the print data may be used. Like this, although there are various methods for the pre-light emission, a method is preferable whose setting can be changed depending on properties of the dot array head 22 or exposure qualities needed. In addition, from a view of reducing the temperature difference between the image area and the non-image area, the pre-light emission is preferable to enable all the fluorescent light-emitting devices to emit the lights at a same duty. Additionally, in order to reduce the exposure non-uniformity due to the attachment of the remaining gas, it is preferable to make all the fluorescent light-emitting devices emit the lights at a full duty.

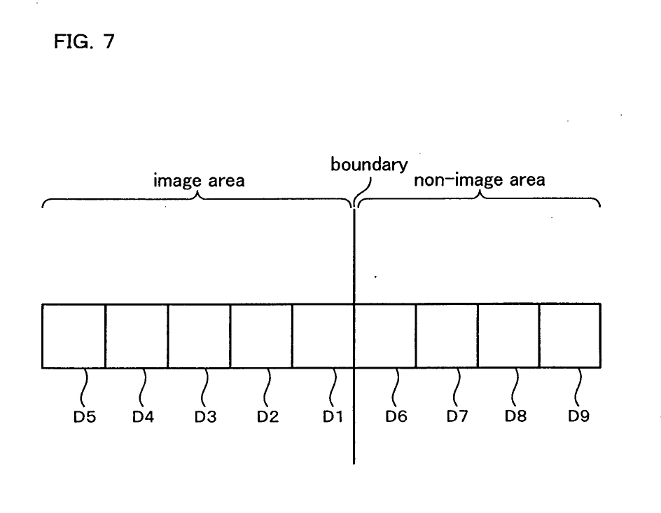

In the followings, a sequence of creating the dummy light emission data in the dummy light emission data creating unit 57 is described with reference to FIG. 7. FIG. 7 shows a part adjacent to a boundary of an image area and a non-image area.

In FIG. 7, dots, which are formed on a photosensitive surface of the photographic paper 1 and disposed along a width direction of the photographic paper 1, are shown with a square (□). In FIG. 7, the dots D1˜D5 are dots adjacent to the boundary in the image area and sequentially disposed from the boundary to an inner side of the image area. Herein, although there are many cases where the image data corresponding to each of the dots D1˜D5 are different from each other, there is a case where at least two are same. In addition, the dots D6˜D9 are dots adjacent to the boundary in the non-image area and sequentially disposed from the boundary to an outer side of the image area. Herein, although only the part adjacent to the boundary of the image area and the non-image area is exemplified, parts adjacent to the boundaries of the other image areas and non-image areas are also same.

The dummy light emission data creating unit 57 acquires, from the HD in which the image data read through the scanner 62 is stored, the image data corresponding to the dot D1 disposed at the outermost of the image area, i.e., a single dot D1 adjacent to the boundary of the image area and the non-image area, and creates dummy light emission data relating to the dummy light emission in the non-image area, based on the acquired image data. In other words, the dummy light emission data relating to the dummy light emission in the non-image area, which is created in the dummy light emission data creating unit 57, is same as the dot D1 disposed at the outermost of the image area.

Accordingly, in this embodiment, when exposing the photographic paper 1, the dots D1˜D5 adjacent to the end of the image area are exposed based on the image data corresponding to each of the dots, and the dots D6˜D9 of the non-image area at the outside of the image area are dummy-exposed based on the image data corresponding to the dot D1. Like this, since the dot D1 and the dot D6 interposing the boundary of the image area and the non-image area therebetween are exposed based on the same image data, it is possible to suppress the exposure non-uniformity due to the temperature quenching characteristic adjacent to the end of the image area.

In the mean time, with respect to the dummy light emission in the non-image area of the dot array head 22, the light emission is preferably performed at the same timing as the timing of exposing the image data to the photographic paper 1 in the image area, for the same time period. By doing so, it is possible to effectively suppress the exposure non-uniformity due to the temperature quenching characteristic of the dot array head 22. However, the invention is not limited to the case where the dummy light emission in the non-image area and the light emission in the image area are necessarily performed at the same timing for the same time period.

As described above, in the exposure apparatus according to this embodiment, the area dividing unit 56 divides the dot array head 22 into the image area, in which the control of the light emission based on the image data relating to the exposure is performed, and the other non-image areas. When exposing the photographic paper 1, the dot array head 22 is controlled in the light emission control unit 55a so that the light not only is emitted in the image area, the dummy light emission also takes place in the non-image area based on the image data corresponding to the single dot of the end of the image area. Like this, the overall dot array head 22 is made to emit the light in exposing, so that it is possible to suppress the exposure non-uniformity due to the temperature quenching characteristic, more effectively. In other words, since a difference of steps at the boundary of the image area and the non-image area is not conspicuous, there is no inconvenience in appearance. Accordingly, even when a width of the photographic paper 1 is changed to increase a print width, since a difference of steps at the boundary of the image area and the non-image area disappears, a partial density difference is drastically suppressed, so that it is possible to cope with prints of various sizes.

In addition, as the dummy light emission takes place in the non-image area also, it is possible to reduce the time of the pre-light emission, which has been conventionally carried out as measures for the exposure non-uniformity resulting from a difference of attachment amounts of the remaining gas in the dot array head 22. Additionally, since a difference of total light emission time of the respective fluorescent light-emitting devices becomes small and a difference of amounts of light emission between the respective devices, as time goes by, is thus lessened, it is possible to reduce the processing time required for a light quantity uniforming process carried out in advance so that the amounts of light emission of the fluorescent light-emitting devices are uniform. Accordingly, it is possible to suppress the exposure non-uniformity while sustaining the high processing capacity. Further, since the time of the pre-light emission, which is typically carried out for the overall dot array head 22, can be reduced, the load for the dot array head 22 is decreased and the lifespan of the light emission is thus prolonged, as compared to the prior art.

Additionally, according to the embodiment, it is carried out the pre-light emission process for applying the load to the overall dot array head 22 before the exposure of the photographic paper 1, in addition to the dummy light emission. Therefore, since the temperature difference between the image area and the non-image area is decreased, it is possible to further suppress the exposure non-uniformity due to the temperature quenching characteristic and at the same time to suppress the exposure non-uniformity due to the difference of the attachment amounts of the remaining gas. Accordingly, it is possible to achieve a higher quality print.

In addition, according to the embodiment, the dot array head 22 is a VF head. In this case, the exposure non-uniformity due to the temperature quenching characteristic is conspicuous. However, with the structure as described above, it is possible to effectively suppress the exposure non-uniformity due to the temperature quenching characteristic while sustaining the high processing capacity.

For example, in the above embodiment, the dummy light emission data creating unit 57 creates the dummy light emission data relating to the dummy light emission in the non-image area, based on the image data, among the image data used for light emission in the image area, corresponding to a single dot adjacent to the boundary of the image area and the non-image area. However, it may create the dummy light emission data based on image data, among the image data used for light emission in the image area, corresponding to several dots adjacent to the boundary of the image area and the non-image area. Accordingly, the dummy light emission data creating unit may create the dummy light emission data based on an average value of the image data, among the image data used for light emission in the image area, corresponding to the several dots adjacent to the boundary of the image area and the non-image area. In other words, the dummy light emission data creating unit may create the dummy light emission data based on an average value of the image data of the dots D1˜D3 or based on an average value of the image data of the dots D1˜D5 in FIG. 7. In the mean time, among the image data used for light emission in the image area, the dots adjacent to the boundary of the image area and the non-image area are preferably a dot number of 1% or less of the dot number corresponding to an overall width of the image area.

In addition, although the dot array head 22 of the embodiment can emit the lights of three primary colors, i.e., red (R), green (G) and blue (B), the other structures may be adopted. Further, although the exposure apparatus of the embodiment has the pre-light emission control unit 58 to carry out a pre-light emission process, it may carry out the dummy light emission only without the pre-light emission process.

Additionally, according to the embodiment, the photographic paper 1 is cut before the exposure. However, the photographic paper may be cut into a necessary size after the exposure. Further, although the exposure apparatus of the embodiment is a hybrid type capable of performing the digital exposure and the analog exposure, it may be a full digital type that performs the digital exposure only, without the light source 11, the mirror 12, the dimmer filter 13, the optical lens 15, the shutter 16 and the like of the projection exposure unit B. Additionally, the invention can be a variety of apparatuses in addition to the photograph print system.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. An exposure apparatus comprising:
a dot array head that exposes a photosensitive medium based on an image data item;
an area dividing unit that divides the dot array head into an image area, in which control of light emission based on an image data item relating to exposure is performed, and a non-image area;
a light emission control unit that controls the dot array head so that light is emitted based on the image data item in the image area and dummy light emission takes place in the non-image area when the photosensitive medium is exposed; and
a dummy light emission data item creating unit that creates a dummy light emission data item relating to the dummy light emission in the non-image area, based on image data items, among the image data items used for light emission in the image area, corresponding to a plurality of dots adjacent to a boundary of the image area and the non-image area.

2. The exposure apparatus according to claim 1, wherein the dummy light emission data item creating unit creates the dummy light emission data item, based on an image data item, among the image data items used for light emission in the image area, corresponding to a single dot adjacent to the boundary of the image area and the non-image area.

3. The exposure apparatus according to claim 1, wherein the light emission control unit performs pre-light emission for the dot array head before exposure of the photosensitive medium.

4. The exposure apparatus according to claim 1, wherein the dot array head is a vacuum fluorescent print head.

5. The exposure apparatus according to claim 2, wherein the light emission control unit performs pre-light emission for the dot array head before exposure of the photosensitive medium.

6. The exposure apparatus according to claim 2, wherein the dot array head is a vacuum fluorescent print head.
